(19) United States
(12) Patent Application Publication
(10) Pub. No.: US 2025/0371580 A1
(43) Pub. Date: Dec. 4, 2025

(54) ENHANCING BUSINESS INTERACTIONS USING A SMART WALLET

(71) Applicant: Wells Fargo Bank, N.A., San Francisco, CA (US)

(72) Inventor: Misung Kim, San Francisco, CA (US)

(21) Appl. No.: 18/733,626

(22) Filed: Jun. 4, 2024

(51) Int. Cl. G06Q 30/0251; G06Q 20/36

(52) U.S. Cl. CPC G06Q 30/0269; G06Q 20/36

(57) ABSTRACT

An example computer system for enhancing device interaction can include: one or more processors; and non-transitory computer-readable storage media encoding instructions which, when executed by the one or more processors, causes the computer system to: receive a virtual identification (ID) by a smart wallet; determine an interaction process to initiate with a client device; query the smart wallet to access user information of the virtual ID based on a determined interaction process; and initiate the interaction process with the client device using the user information of the virtual ID.

### BACKGROUND

Service providers use static demographic information about customers for various business purposes. This static information is not easily refreshed when customer demographic information changes. For instance, customers often fail to update every service provider when they move. It is difficult to manually curate customer demographic information across a large customer base. As a result, customer information becomes outdated and less useful.

In addition, service providers use dynamically changing data regarding their users for business purposes. For instance, smartphones and similar devices enable the retrieval and use of users' real-time geolocation information for hyper-personalized advertisements. The personalized advertisements are generally relevant to real-time geolocation; thus, the users may be more likely to interact with them. However, personalized advertisements benefit from access to more permanent data of the users.

### SUMMARY

Examples provided herein are directed to tools for using a smart wallet for enhancing business interactions.

According to one aspect, a computer system for enhancing device interaction can include: one or more processors; and non-transitory computer-readable storage media encoding instructions which, when executed by the one or more processors, causes the computer system to: receive a virtual identification (ID) by a smart wallet; determine an interaction process to initiate with a client device; query the smart wallet to access user information of the virtual ID based on a determined interaction process; and initiate the interaction process with the client device using the user information of the virtual ID.

According to another aspect, a method for enhancing device interaction can include: receiving a virtual identification (ID) by a smart wallet; determining an interaction process to initiate with a client device; querying the smart wallet to access user information of the virtual ID based on a determined interaction process; and initiating the interaction process with the client device using the user information of the virtual ID.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows aspects of one example system programmed to enhance interactions using a virtual identification.

FIG. 2 shows example logical components of a server device of FIG. 1.

FIG. 3 shows the example system of FIG. 1 in an example environment for providing a business recommendation.

FIG. 4 shows an example method for interacting with a user device using the system of FIG. 1.

FIG. 5 shows example physical components of the server device of FIG. 2.

### DETAILED DESCRIPTION

This disclosure relates to utilizing a virtual identification (ID) to enhance business interactions. As more services are offered digitally, users have begun to migrate traditional services, such as a wallet with credit cards, to digital systems, such as their smartphones or other computing devices. In addition, driver licenses can also be offered in a digital format, such as a mobile driver license. Other virtual IDs may be offered as well. Storing these items in a digital format helps combat loss and theft. For example, a user may lose, drop, or have stolen their credit cards and/or driver's license. Keeping these items in a smart wallet stores them in the cloud where they cannot be made unavailable so easily.

Smart wallets offer many features of a traditional wallet but in a digital format. Credit cards, IDs, e-tickets, coupons, user accounts, and other digital items can be stored in the smart wallet. Further, the smart wallet includes functionality to use communication features of an associated device to communicate with other devices to access the stored items. For example, a user can place a device with a smart wallet that includes a credit card near a payment device to pay for items. User accounts can also be associated with the smart wallet.

Virtual IDs can be stored in the smart wallet. In addition, the virtual ID often includes important user information. For example, a virtual ID may be a mobile driver's license. A mobile driver license may have the user's permanent address. The address may provide a location that is more relevant for user interactions and business tasks. For example, a user's home address may be more useful than the user's geolocation when providing an advertisement for a location to eat later that evening. The user may be currently at the user's place of work, which is away from the user's house, but the user likely will move towards their house after the workday.

Thus, recommending restaurants to the user near their address of the house in their virtual ID is more relevant than those near the user's geolocation since they will likely depart for their address around dinner time. Other business interactions can use the user's information from the virtual ID as well. Accordingly, the system mitigates business errors caused from use of erroneous or out-of-date static customer demographic information by automatically using user information of a virtual ID to enhance business tasks.

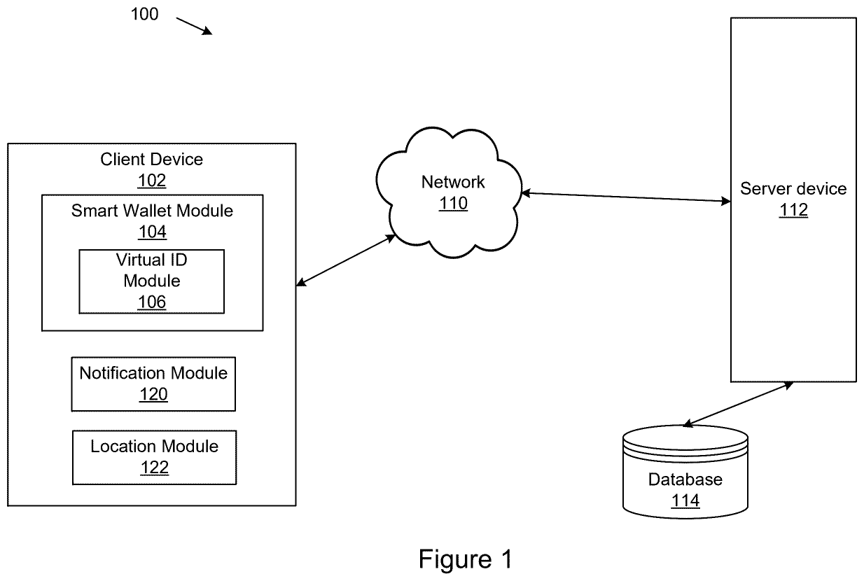

FIG. 1 schematically shows aspects of one example system 100 programmed to enhance interactions using a virtual ID. In this example, the system 100 can be a computing environment that includes a plurality of client and server devices. In this instance, the system 100 includes a client device 102, a server device 112, and a database 114. The client device 102 includes a smart wallet module 104, which also has stored within a virtual ID module 106. The client device 102 and the server device 112 connect through the network 110. Further, the server device 112 connects to the database 114.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank. The client device 102 can be programmed to communicate with the server device 112 to perform various tasks, such as financial transactions. Many other configurations are possible, and the disclosure is not limitation to the financial industry. For example, the server device 112 can be configured to provide advertisements (“ads”) to a user. In other embodiments, the server device 112 provides some other user service.

The example client device 102 is configured to provide services to a user. For example, the client device 102 may provide a user interface to receive inputs and interact with the server device 112. In some embodiments, the client device 102 is configured to provide notifications or pop-ups. The notifications display on a display of the client device 102, and the client device 102 may allow interactions such as selecting the notification. Selecting the notification may perform a business task or redirect the user to a specific application or website.

In this embodiment, the client device 102 includes the smart wallet module 104. The smart wallet module 104 is configured to store virtual representations of items. These items may normally be stored in a physical wallet. For example, smart wallet module 104 may store virtual representations of credit cards. Further, the virtual representations can include the credit card information (e.g., card number, security code, name, address, etc.) associated with the physical card. In some embodiments, these virtual representations have generated tokens associated with the virtual representations. The tokens can then be provided to a payment system instead of the credit card's information.

The smart wallet module 104 stores digital items associated with the user of the client device 102. Further, the smart wallet is configured to store virtual representations of physical payment cards and other items found in a wallet. The smart wallet module 104 is configured to communicate with the server device 112. This communication may utilize various application and network protocols to connect through the network 110. For example, the server device 112 may manage the smart wallet module 104 as a server side application. In some embodiments, the smart wallet module 104 sends stored virtual representations of payment cards to the server device 112 for storage in the cloud. In some embodiments, the smart wallet module 104 is configured to use near field communications (NFC) to communicate with a nearby payment system. The smart wallet module 104 uses a selected virtual payment card to send payment for a goods or services.

In some embodiments, the smart wallet module 104 can be managed by an entity such as a financial institution. The entity managing the smart wallet module 104 can include encryptions of user data and associated login information. In some embodiments, the smart wallet module 104 links to additional service provider accounts. For example, the server device 112 may manage the smart wallet module 104 as an application that is executed on the client device 102.

The virtual ID module 106 of the smart wallet module 104 provides services for a digital ID that stores user information. The user information can be identification information of the user. In some embodiments, the virtual ID module 106 stores a mobile driver's license associated with the user of the client device 102. The mobile driver's license can include various information about the user. This information can include a permanent physical address, driver's license number, date of birth, and other associated information. Further, the information may be information submitted to the government for official identification purposes. Accordingly, an address listed in the mobile driver's license may be more accurate on account of the official nature of a driver's license.

In some embodiments, the user information associated with the virtual ID module 106 is also stored in a remote database, such as the database 114. For example, the server device 112 encrypts the information associated with the virtual ID module 106, associates the information with a user account, and stores the information of the virtual ID module 106. Such information is then accessible by the virtual ID module 106 of the client device 102.

In addition, the virtual ID module 106 may receive information in a variety of formats. In some embodiments, the information of the virtual ID module 106 is received from a government server. For example, the state department of transportation (DOT) may maintain a database with all mobile driver's license for residents of the state. The government server can then be accessed by the client device 102 to download the government ID information to the virtual ID module 106. In some embodiments, the information of the virtual ID module 106 may also be stored in the database 114 by the server device 112. In other embodiments, the client device 102 includes a camera that captures an image of a user's physical driver's license. The image is then scanned to obtain the user's information associated with the physical driver's license. A mobile driver's license is then created and stored as the virtual ID module 106.

In some embodiments, the smart wallet module 104 may restrict access to user information of the virtual ID module 106. Once the virtual ID module 106 is added to the smart wallet module 104, the smart wallet module 104 may be initialized based on the user's comfort level with third party use of data from the virtual ID module 106. For instance, the smart wallet module 104 may restrict access to a listed user home address but may allow access to the zip code of the home address. As another example, the smart wallet module 104 may restrict access to the listed user age but may allow access to an age range of the user (<21, 21-30, 31-55, 55+, etc.). Once initialized, other applications may query the smart wallet module 104 to enable enhanced demographic-based business processes.

In the shown embodiment, the database 114 stores data for use by the server device 112. In some embodiments, the database 114 stores user account data for the entity that manages the server device 112. For example, the financial institution may manage the server device 112 and users with accounts of the financial institution have their account information stored in the database 114. In some embodiments, the virtual ID module 106 may also be stored in the database 114 by the server device 112. Storing this data in the database 114 enables multiple devices of a user to generate their own virtual ID module 106 that are all associated with the same virtual ID. In addition, the data within the database 114 is encrypted to securely store the data.

The client device 102 also stores a notification module 120. The notification module 120 manages notifications displayed or otherwise output on the client device 102. A notification provided by the notification module 120 can alert the user to a status of an application or the notification indicates that the application requires feedback. For example, the smart wallet module 104 may use the notification module 120 to request input to select a data sharing level. The data sharing level determines how much of the user's data that an application or service can access. For example, a user may select a data sharing level that allows a service to access their zip code and an age range. In some embodiments, the notification module 120 provides suggested ads from the ad delivery module 210.

The client device 102 also stores a location module 122. The location module 122 is configured to determine a location of the client device 102. In some embodiments, the location module 122 uses satellite antennas that use GNSS data to calculate a position. Further, the location module may use cellular data or Wi-Fi signals that include location data to calculate the position of the client device 102. In some embodiments, the location module 122 provides a position of the client device 102 to the server device 112 for use in conjunction with described business services. In some embodiments, the location module 122 tracks location of the client device 102 over a period of time to generate a location history. The location history may also be used by the server device 112.

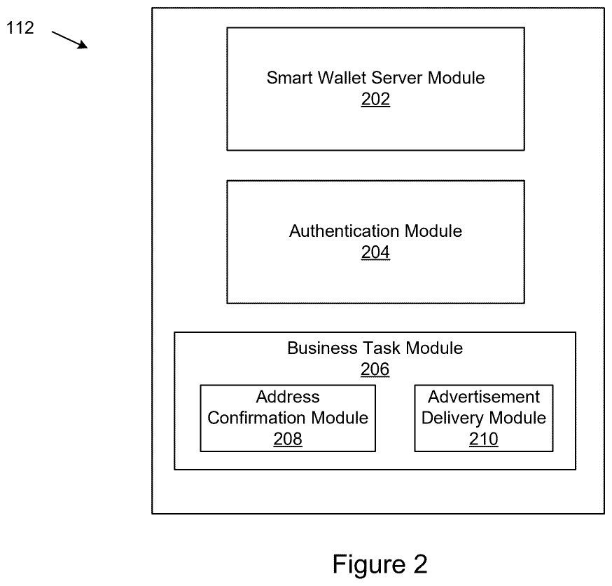

Referring now to FIG. 2, example components of the server device 112 are shown. In the shown embodiment, the server device 112 includes a smart wallet server module 202, an authentication module 204, and a business task module 206. The business task module 206 includes an address confirmation module 208, an advertisement delivery module 210, and a security module 212.

The smart wallet server module 202 provides smart wallet server features that include communicating with the smart wallet module 104 to maintain server information of the smart wallet module 104. In some embodiments, the smart wallet server module 202 stores data associated with the smart wallet module 104 so it can be accessed from multiple devices. Accordingly, the smart wallet server module 202 maintains the “cloud” infrastructure for operating a smart wallet module 104.

In some embodiments, the smart wallet server module 202 stores virtual card data stored in the smart wallet. For example, the smart wallet server module 202 stores physical credit card information in the form of virtual credit card data for access by a device with the proper credentials. Additional virtual representations may be stored as well. For example, the virtual ID module 106 can also be stored and retrieved by the smart wallet server module 202. In some embodiments, the smart wallet server module 202 encrypts the data that it stores.

Further, the smart wallet server module 202 can manage payment data associated with a virtual card stored within the smart wallet. For example, a user may use a stored virtual payment card within the smart wallet to pay at a vendor. The smart wallet module 104 generates a token that is passed to the payment system of a vendor. The payment system then sends the token to the server device 112. The smart wallet server module 202 then uses the token to access stored data associated with the payment card. Then, the smart wallet server module 202 initiates a payment transaction using the card information associated with the token. In some embodiments, the smart wallet server module 202 manages stored virtual payment cards associated with third party services.

In some embodiments, the smart wallet server module 202 also stores preferences for data sharing. For example, the client device 102 may receive input indicating that address data from the virtual ID module 106 can be shared with third parties. Other user information can be indicated as shareable as well. The smart wallet server module 202 receives the preferences from the smart wallet module 104 and stores the preferences as data. In some embodiments, the smart wallet server module 202 allows other applications and services to access stored virtual ID address data based on the stored preference data.

In addition, the authentication module 204 of the server device 112 provides authentication services. The authentication services include verifying the client device 102 has appropriate permissions to access accounts and data associated with the smart wallet module 104. For example, the client device 102 may request data associated with the smart wallet module 102. The authentication module 204 determines that the requesting device has permission to access data of the smart wallet module 104. In some embodiments, the authentication module 204 requests a password associated with the smart wallet module 104. In other embodiments, the authentication module 204 requests a passkey from the client device 102. For example, the authentication module 204 may send a notification requesting the user to authenticate themselves before the server device 112 provides data associated with the smart wallet module 104 to the client device 102. The user may authenticate themselves through a passkey, such as matching their fingerprint or face unlock, through a password, or a PIN.

The business task module 206 of the server device 112 provides features for performing business interactions with the client device 102. Further, the business task module 206 communicates with the smart wallet module 104 through network 110 to send notifications, advertisements, or other data. The communication between the business task module 206 and the smart wallet module 104 may be through an application programming interface (API). The business task module 206 may query the virtual ID module 106 stored in the smart wallet module 104 to obtain the address of the virtual ID module 106. The sent data from the business task module 206 may be used by other modules or applications operated by the client device 102. For example, the business task module 206 may communicate and exchange data with the smart wallet module 104 through the smart wallet server module 202.

Included services operate to perform tasks that accomplish a business function. For example, the business task module 206 may include a service to send a new payment card to a stored address of the user. Other embodiments include offering online banking services to the user. The business task module 206 enables access by another device to a financial institution. In addition, the business task module 206 can receive instructions to deposit funds, withdraw funds, or transfer funds to another account. The business task module 206 can offer a variety of services. In some embodiments, the business task module 206 accesses the smart wallet server module 202 for relevant user data based on user preferences.

In the shown embodiment, the address confirmation module 208 of the business task module 206 provides for detecting the address of the virtual ID module 106. For example, a physical payment card is lost, stolen, or about to expire. The address confirmation module 208 uses an address associated with the user account of the physical card to mail the new payment card.

In some embodiments, a physical payment card is associated with a virtual payment card stored in the smart wallet module 104 of the user. Before sending the physical payment card, the address confirmation module 208 accesses the stored virtual ID module 106 within the same smart wallet module 104 to compare addresses. The address confirmation module 208 determines that the address of the virtual ID module 106 is different from the address associated with the user account indicating the address of the user account is static or out-of-date. Accordingly, the address confirmation module 208 can be configured to send the physical card to the address of the virtual ID module 106 instead of the old address of the user account. In some embodiments, the address confirmation module 208 sends a notification to the client device 102 requesting verification of the address change. The client device 102 can then receive input indicating if the address change is correct. In some embodiments, the address confirmation module 208 uses a location history of the client device 102 to determine the virtual ID module 106 address is correct. In other embodiments, the address confirmation module 208 uses the location data of the client device 102 to determine if the old user account address is no longer a valid address.

The advertisement delivery module 210 of the business task module 206 provides advertisement delivery services for delivering advertisements to the client device 102. The advertisements may be curated to a user profile of the client device 102. The business task module 206 is configured to send ads to a device such as the client device 102. In some embodiments, the advertisements are tailored based on user data. For example, the advertisement delivery module may send a restaurant advertisement for a restaurant near a determined location. The determined location may be based on obtained location data of the client device 102. Accordingly, the restaurant associated with the advertisement may be relevant to the user since it is near the location of the client device 102. In other embodiments, the advertisement delivery module 210 provides an advertisement based on user browser history.

In some embodiments, the advertisement delivery module 210 accesses the virtual ID module 106. The ad delivery module 210 can use the user information of the virtual ID to tailor the advertisement provided to the client device 102. For example, the advertisement delivery module 210 may determine the user's current address from the virtual ID. Rather than recommending a restaurant near the location of the client device 102, the advertisement delivery module 210 may be configured to provide an advertisement associated with a restaurant near the address of the virtual ID module 106. The restaurant near the address of the virtual ID module 106 may be more relevant to the user since that address is their likely next destination.

In alternative embodiments, the client device 102 can also include additional functionality, including functionality described herein as being performed by the server device 112. For instance, the client device 102 can include one or more of the functionalities provided above performed by the business task module 206, address confirmation module 208, or the advertisement delivery module 210 of the server device 112.

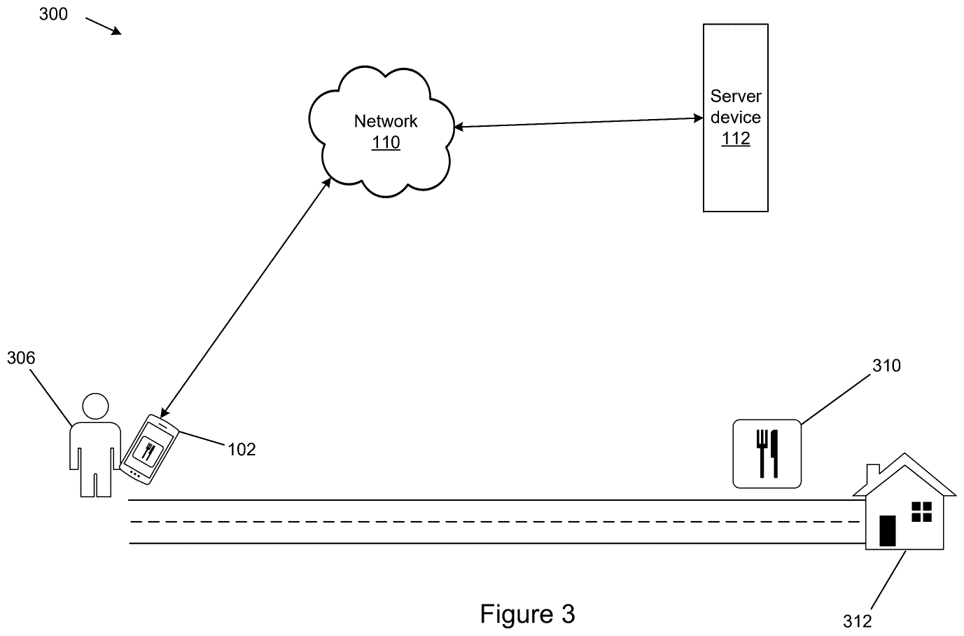

Referring now to FIG. 3, the example environment includes the client device 102 connecting to the server device 112 through the network 110. In addition, the user 306 has the client device 102. A restaurant 310 is also located near the house 312 of the user 306.

In this embodiment, the user 306 is at a location remote from their house 312. While away, the client device 102 is configured to provide an advertisement for a restaurant. Instead of providing an advertisement for a restaurant near the user's 306 current location, the server device 112 determines the user's address from the virtual ID module 106. The server device 112 determines the user is likely to head home, thus, it provides an ad to the client device 102 for the restaurant 310 near the house 312.

While shown as example embodiment, different business tasks can be enhanced using the virtual ID module 106. In some embodiments, the client device 102 displays an advertisement for a retail location. The retail location advertisement may be tailored based on an age range of the user 306 and the address of the user 306, both of which are obtained from the virtual ID module 106.

Enhanced demographics can permit improved advertising as previously discussed. In addition, an address associated with the virtual ID of the virtual ID module 106 can be used by a financial institution to mail a replacement payment card. For example, a user may request a new payment card. However, the address associated with the user's account stored in database 114 is out of date. The server device 112 may access the address stored within the virtual ID module 106 to determine the location to mail the new payment card. In some embodiments, the server device 112 sends the user information from the virtual ID to a third-party server. The third-party server then sends an advertisement to the client device 102 based on the received user information of the virtual ID module 106.

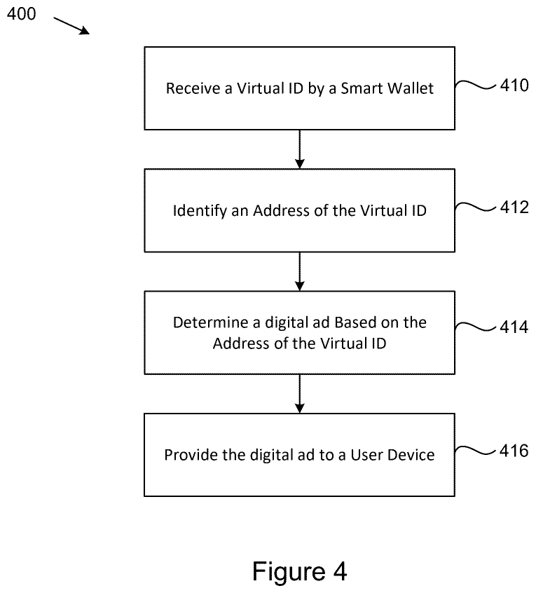

Referring to FIG. 4, the method 400 includes operations 410-416 for using user information of a virtual ID to enhance interactions with a user device. In this embodiment, the virtual ID is a mobile driver's license. The mobile driver's license includes an address of 123 Main Street.

At operation 410, a virtual ID is received by a smart wallet. In some embodiments, the virtual ID is then shared with a server that is configured to provide business interactions. Proceeding to operation 412, an address of the virtual ID is identified. In some embodiments, other user information of the virtual ID is identified. For example, a date of birth of the user, gender of a user, or other user information may be identified.

At operation 414, a digital advertisement is determined based on the address of the virtual ID. In some embodiments, the digital advertisement is determined based on its proximity to the address of the virtual ID. In some embodiments, other context data is considered to determine the digital advertisement, such as a time of day. In other embodiments, the address is compared to a current location of a user device. The current location (i.e., geolocation) of the user device and the address of the virtual ID may be factored in determining the digital advertisement. Further, a relevance of the digital advertisement may be determined. The relevance is then used to determine whether the digital advertisement is provided to the user. In some embodiments, the relevance of the digital advertisement is based on a user profile. The digital advertisement is then provided to the user device at operation 416. In some embodiments, the digital advertisement is for a restaurant near the address of the virtual ID.

In some embodiments, the method 400 further includes providing a notification by a user device. The notification may request input to indicate the address of the virtual ID can be shared. In other embodiments, the method 400 also includes displaying the digital advertisement on the user device.

Other business operations may be performed in association with method 400 as well. For example, a financial institution may use a similar method to method 400 to provide a new payment card. The address is compared to a stored address of a user account associated with the virtual ID. Based on a determination that the address of the user account and the address of the virtual ID do not match; a notification is displayed on the user device requesting verification of updating the user account address to the address of the virtual ID. After updating the address, the financial institution sends a new payment card to the updated address. Additional business operations can be performed as well. For example, an interaction can be determined based on user information of the virtual ID. The interaction can then be initiated.

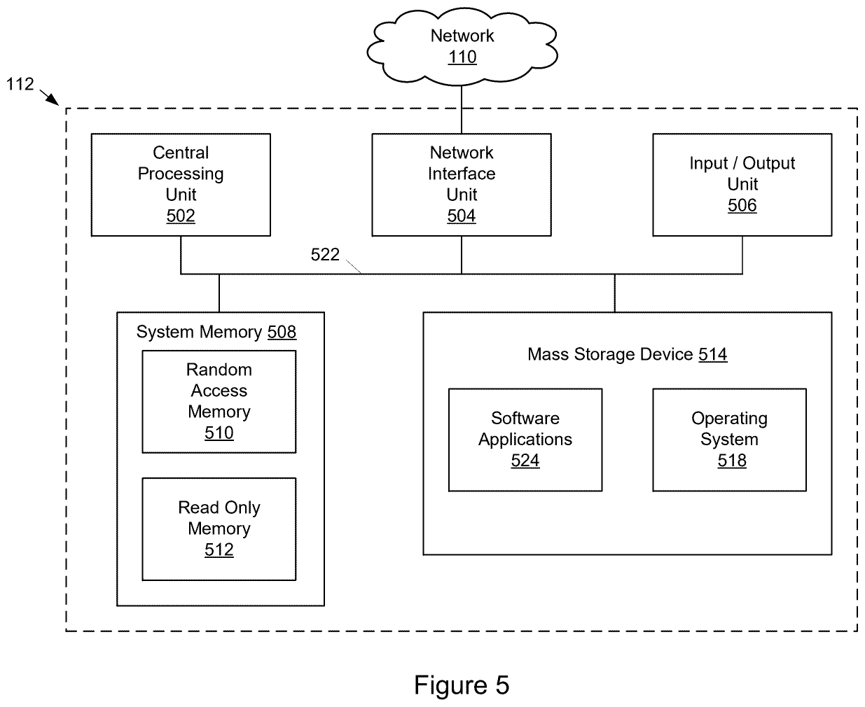

As illustrated in the embodiment of FIG. 5, the example server device 112, which provides the functionality described herein, can include at least one central processing unit (“CPU”) 502, a system memory 508, and a system bus 522 that couples the system memory 508 to the CPU 502. The system memory 508 includes a random-access memory (“RAM”) 510 and a read-only memory (“ROM”) 512. A basic input/output system containing the basic routines that help transfer information between elements within the server device 112, such as during startup, is stored in the ROM 512. The server device 112 further includes a mass storage device 514. The mass storage device 514 can store software instructions and data. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 504 connected to the system bus 522. It should be appreciated that the network interface unit 504 may also be utilized to connect to other types of networks and remote computing systems. The server device 112 also includes an input/output controller 506 for receiving and processing input from a number of other devices, including a touch user interface display screen or another type of input device. Similarly, the input/output controller 506 may provide output to a touch user interface display screen or other output devices.

As mentioned briefly above, the mass storage device 514 and the RAM 510 of the server device 112 can store software instructions and data. The software instructions include an operating system 518 suitable for controlling the operation of the server device 112. The mass storage device 514 and/or the RAM 510 also store software instructions and applications 524, that when executed by the CPU 502, cause the server device 112 to provide the functionality of the server device 112 discussed in this document.

While the discussed components and functions are discussed in association with the server device 112, some or all of the components and functions may be performed by the client device 102 or another device.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for enhancing device interaction, the computer system comprising:
one or more processors; and
non-transitory computer-readable storage media encoding instructions which, when executed by the one or more processors, causes the computer system to:
receive a virtual identification (ID) by a smart wallet, wherein the virtual ID comprises a mobile driver's license;
determine an interaction process to initiate with a client device;
query the smart wallet to access user information of the virtual ID based on a determined interaction process, wherein the user information comprises a permanent physical address submitted to a government for official identification purposes;
track location of the client device over a period of time to generate a location history;
analyze the location history to confirm an accuracy of the permanent physical address;
obtain a current location of the client device using global positioning data;
compare the permanent physical address of the virtual ID with the current location of the client device;
determine a digital advertisement based on the permanent physical address rather than the current location of the client device when the permanent physical address and the current location differ; and
initiate the interaction process with the client device using the user information of the virtual ID, wherein initiating the interaction process comprises providing the digital advertisement to the client device.

2-5. (canceled)

6. The computer system of claim 1, wherein to initiate the interaction process includes to send a payment card to the permanent physical address.

7. The computer system of claim 6, encoding further instructions which, when executed by the one or more processors, causes the computer system to provide a notification requesting verification of the permanent physical address of the virtual ID.

8. (canceled)

9. The computer system of claim 1, encoding instructions which, when executed by the one or more processors, causes the computer system to provide a notification to the client device, wherein the notification requests input indicating the user information is shareable.

10. The computer system of claim 1, encoding instructions which, when executed by the one or more processors, causes the computer system to receive input restricting access to at least some of the user information.

11. A method for enhancing device interaction, the method comprising:
receiving a virtual identification (ID) by a smart wallet, wherein the virtual ID comprises a mobile driver's license;
determining an interaction process to initiate with a client device;
querying the smart wallet to access user information of the virtual ID based on a determined interaction process, wherein the user information comprises a permanent physical address submitted to a government for official identification purposes;
tracking location of the client device over a period of time to generate a location history;
analyzing the location history to confirm an accuracy of the permanent physical address;
obtaining a current location of the client device using global positioning data;
comparing the permanent physical address of the virtual ID with the current location of the client device;
determining a digital advertisement based on the permanent physical address rather than the current location of the client device when the permanent physical address and the current location differ; and
initiating the interaction process with the client device using the user information of the virtual ID, wherein the initiating of the interaction process comprises providing the digital advertisement to the client device.

12-15. (canceled)

16. The method of claim 11, wherein initiating the interaction process includes sending a payment card to the permanent physical address.

17. The method of claim 16, further comprising providing a notification requesting verification of the permanent physical address of the virtual ID.

18. (canceled)

19. The method of claim 11, further comprising providing a notification to the client device, wherein the notification requests input indicating the user information is shareable.

20. The method of claim 19, further comprising receiving input restricting access to at least some of the user information.
